(19) United States
(12) Patent Application Publication
(10) Pub. No.: US 2011/0104452 A1
(43) Pub. Date: May 5, 2011

(54) BLOCK COPOLYMER MORPHOLOGY TRAPPING IN THIN FILMS USING LOW TEMPERATURE TREATMENT AND ANNEALING FOR INHIBITION OF MARINE ORGANISM ATTACHMENT TO SURFACES

(76) Inventors: Claudia M. Grozea, Mississauga (CA); Gilbert C. Walker, Mississauga (CA)

(21) Appl. No.: 12/764,731

(22) Filed: Apr. 21, 2010

Related U.S. Application Data
(63) Continuation-in-part of application No. PCT/CA2009/001508, filed on Oct. 21, 2009.
(60) Provisional application No. 61/137,000, filed on Oct. 21, 2008.

(51) Int. Cl. C09D 5/16; B05D 3/10; B05D 3/06; B32B 3/10

(52) U.S. Cl. 428/195.1; 522/46; 427/256; 427/510; 427/519; 427/287

(57) ABSTRACT

The present invention provides block copolymer films for application to surfaces exposed to marine environments in order to reduce biofouling of surfaces immersed in the marine environment. The present invention provides a method of fabricating block copolymer films using morphology trapping by lower temperature treatment in conjunction with solvent and or temperature annealing. The present invention inhibits the attachment of marine organisms, but it does not kill the organisms nor is it highly toxic. Cross-linked AB diblock or higher block copolymers, where A and B and any additional blocks if present have different hydrophobicity i.e. A is hydrophobic and B is hydrophilic, mixed with a photo-initiator films that preserve their nanosize domains when immersed in water. The block copolymer films inhibit settlement of marine organisms and can be used as marine antifouling coatings.

### RELATED PATENT APPLICATIONS

This patent application is a Continuation-in-part application of PCT/CA2009/001508 filed on 21 Oct. 2009, which claims priority of the U.S. provisional patent application No. 61/137,000 filed on Oct. 21, 2008, the whole content of both applications being incorporated herein by explicit reference for all intents and purposes.

### GOVERNMENT SUPPORT

The subject matter of this application has been supported in part by U.S. Government Support under the Office of Naval Research RIS Fund No. 458844. Accordingly, the U.S. Government has certain rights in this invention.

### FIELD OF THE INVENTION

The present invention relates to materials and methods for obtaining block copolymer films on surfaces in order to reduce biofouling of the surfaces immersed in a marine environment. The block copolymer films/coatings inhibit the attachment of marine organisms. The block copolymers may be diblock, triblock or higher number of block copolymers.

### BACKGROUND OF THE INVENTION

Marine biofouling is a problem for structures that are immersed in water. These structures include aquaculture cages, boat hulls, pontoons, water pipes or sewage pipes but are not limited to these structures. Marine organisms such as alga or barnacles settle and colonize on these immersed surfaces. In the aquaculture industry, this biofouling that must be periodically cleaned leads to an estimated 20% increase in the cost of fish production. In the transport industry, biofouling leads to an increase in fuel consumption by an estimated maximum of 30%, and also to an increase in operating and maintenance costs.

The most effective antifouling paints to date are based on tin and copper biocides. These biocides are toxic to marine organisms and cause damage especially when the ships are docked. New regulatory issues resulted in the banning of tributyltin (TBT) coatings in 2008 and will require reduction of Cu in hull coatings in the near future.

New materials must be developed that are non-toxic, have low VOC emissions, possess antifouling properties i.e. inhibit the settlement of marine organisms and/or possess fouling release properties i.e. low adhesion towards the organisms.

Commercial available paints based on polydimethylsiloxane elastomer or silicon polymers meet some of the preferred characteristics. They have low adhesion towards marine organisms i.e. under hydrodynamic conditions they release fouling, and they are non-toxic (Holm et al. [2006] Biofouling 22: 233-243). However, under low or static flow conditions bioaccumulation still occurs (Brady et al. [2000] J. Prot. Coat. Lin. 17: 42-48). In addition, they are not strong enough in a marine environment, do not self-clean adequately and consistently and they can reconstruct and degrade. The longer the polymer is exposed to the marine environment, the higher the increase in the loss of surface properties.

Organisms such as algae zoospores have been shown to respond to a variety of surface properties such as wettability (Ista et al. [2004] Appl. Environ. Microbial. 70: 4151-4157), surface chemistry (Krishnan et al. [2006] Biomacromolecules 7: 1449-1462) and topography (Schumacher et al. [2007] Biofouling 23: 55-62). Recently, polydimethylsiloxane was used to fabricate surfaces with a variety of topographies at the microscale, upon which, due to the design and length-scale of the pattern, settlement of algae zoospores was either promoted or inhibited (Schumacher et al. [2008] Langmuir 24: 4931-4937). However, until this invention polymer nanoscale patterns displaying both physical and chemical patterning have not been investigated for the settlement of organisms such as algae zoospores.

Another attempt at preparing an antifouling coating was done by C. Ober (Ober et al. [2007] US Patent Publication No. 2007/0106040A1). The polymers used had a plurality of two-carbon repeating units in the chain. One or more of the repeating units have tertiary amine or pyridine-containing substituents and at least about 10% of the nitrogen atoms of the tertiary amine or pyridine-containing substituents are quaternized with alkyl groups or with an alkyl group that has one or more ethylene oxide groups. These groups can be at least partially fluorinated. Thus, the polymers used in these studies are charged. The presence of charge makes it difficult to obtain smooth defect-free polymer films. In addition, the films have a large contact angle hysteresis which shows that the polymer is mobile. When the polymer is immersed in water the surface reorganizes and becomes more hydrophilic. The settlement density of Ulva alga zoospores was high possibly due to electrostatic interactions between the marine organism and the charged copolymer. However, the growth of the zoospores was inhibited possibly due to antimicrobial properties.

Related diblock copolymers, polystyrene-block-poly(2-vinyl pyridine) and polystyrene-block-poly(4-vinyl pyridine), but neutral were used for cell-surface interaction studies (Khor et al. [2007] Biomacromolecules 8: 1530-1540). These diblock copolymers were used to fabricate chemically heterogeneous nanopatterned films on mica by dip-coating. Dot-like and worm-like morphologies were obtained. Reorientation of the patterns is observed after incubation and drying due to swelling and contraction of the films. The copolymer is mobile. The fibroblast and mesenchymal progenitor cells preferred to adhere and proliferate on the wormlike patterns.

A common method of improving the nanopatterning in block copolymers films is to use external fields. The diblock copolymer, polystyrene-block-poly(ethylene oxide) was solvent vapor annealed in benzene at room temperature (Kim et al. [2004] Adv. Mater. 16: 226-231). The copolymer self-assembled into a cylindrical nanopattern with very little defects. However, when the films were annealed for long period of times, the films dewetted.

### SUMMARY OF THE INVENTION

The present invention provides both the materials and methods for obtaining block copolymer films in order to reduce biofouling of surfaces immersed in a marine environment. The present invention inhibits the attachment of marine organisms, but it does not kill the organisms nor is it highly toxic.

In an embodiment of the present invention there is provided a method of applying an antifouling coating to a surface for preventing marine biofouling in marine environments, comprising:

dissolving an AB or higher block copolymer in an organic solvent to produce a solution, applying the solution to a surface where A and at least B self-assemble, as an AB or higher block copolymer on the surface into ordered structures to produce nanosized patterns on the surface, exposing said solution to an initiator agent and activating the initiator agent to cross-link the AB or higher block copolymer to form a coating, subjecting said cross-linked AB or higher block copolymer coating to a lower temperature treatment in conjunction with solvent annealing to improve crystallinity of nanostructured domains of the coating, where A and B or other blocks if present each have a different hydrophobicity with the hydrophobicity of the blocks A and B or other blocks if present tailored to target either a specific organism or a group of organisms.

The organic solvent may be acetone or toluene and the lower temperature treatment includes subjecting the coating to a temperature in a range from about below 24° C. to a temperature just above about −94° C.

The organic solvent may be chloroform and the lower temperature treatment includes subjecting the coating to a temperature in a range from about below 24° C. to a temperature just above about −65° C.

A further understanding of the functional and advantageous aspects of the invention can be realized by reference to the following detailed description and drawings.

### BRIEF DESCRIPTION OF THE DRAWINGS

Preferred embodiments of the invention will now be described, by way of example only, with reference to the drawings, in which:

FIG. 1A illustrates a schematic of an AB type diblock copolymer in which the A part of the copolymer chain can have the same or different molecular weight than the B part of the copolymer chain;

FIG. 1B illustrates a schematic of an AB type diblock copolymer which is configured in a lamellar pattern, in which the A parts of one copolymer chain associate with the A parts of another copolymer chain, while the B parts of a copolymer chain associate with other B parts of another copolymer chain;

FIG. 1C illustrates a schematic of an AB type diblock copolymer configured in a cylindrical pattern in which the A parts of a copolymer chain associate with the A parts of another copolymer chain, while the B parts of a copolymer chain associate with other B parts of another copolymer chain;

FIG. 1D illustrates a schematic of a larger lamellar pattern than shown in FIG. 1B formed by using the same molecular weight AB copolymer as in FIG. 1B and a different B type homopolymer in which A parts of a copolymer chain associate with the A parts of another copolymer chain, while the B parts of a copolymer chain associate with other B parts of another copolymer chain and also the B parts of a homopolymer chain;

FIG. 2 phase diagram for diblock copolymers as a function of total degree of polymerization (N), the Flory-Huggins interaction parameter (x) and the volume fraction of the blocks (f). BCC—body center cubic or spherical pattern. HEX—hexagonally packed cylinders or cylindrical pattern. GYR—gyroid pattern. LAM—lamella pattern;

FIG. 3A illustrates a representative AFM height-image of a diblock copolymer film after solvent annealing. The image size is 1 μm×1 μm and the Z range is 20 nm;

FIG. 3B illustrates a representative AFM height-image of a diblock copolymer film after UV cross-linking. The image size is 1 μm×1 μm and the Z range is 20 nm;

FIG. 3C illustrates a representative AFM height-image of a cross-linked diblock copolymer film in water after 1 hour. The image size is 1 μm×1 μm and the Z range is 12 nm;

FIG. 4 illustrates Ulva zoospore settlement studies as the density of spores per mm². Each point is the mean from 90 counts on 3 replicate slides (30 on each wafer). Bars show 95% confidence limits.

FIG. 5A illustrates a representative AFM height-image of a diblock copolymer film with a higher molecular weight than in FIG. 3A after solvent annealing. The image size is 1 μm×1 μm and the Z range is 20 nm;

FIG. 5B illustrates a representative AFM height-image of a diblock copolymer film after 1 hour in water. The image size: 1 μm×1 μm and the Z range is 8 nm;

FIG. 6 illustrates Ulva zoospore settlement studies as the density of spores per mm². Each point is the mean from 90 counts on 3 replicate slides (30 on each wafer). Bars show 95% confidence limits;

FIG. 7A illustrates a representative AFM height-image of a diblock copolymer film on nylon after solvent annealing. The image size is 1 μm×1 μm and the Z range is 40 nm;

FIG. 7B illustrates a representative AFM height-image of a diblock copolymer film on nylon after UV cross-linking. The image size is 1 μm×1 μm and the Z range is 40 nm;

FIG. 7C illustrates a representative AFM phase-image of a cross-linked diblock copolymer film on nylon in water after 2 hours. The image size is 1 μm×1 μm and the Z range is 10°;

FIG. 8A illustrates a representative AFM height-image of a diblock copolymer film with a higher molecular weight than in FIG. 6A on nylon after solvent annealing. The image size is 1 μm×1 μm and the Z range is 20 nm;

FIG. 8B illustrates a representative AFM height-image of a diblock copolymer film on nylon after 2 hours in water. The image size is 1 μm×1 μm and the Z range is 20 nm;

FIG. 9 illustrates Ulva zoospore settlement studies as the density of spores per mm² for various polymers on nylon substrates. Each point is the mean from 90 counts on 3 replicate substrate (30 on each nylon substrate). Bars show 95% confidence limits.

FIG. 10A illustrates a representative AFM height-image of a diblock copolymer film before solvent annealing. The image size: 1 μm×1 μm and the Z range is 30 nm;

FIG. 10B illustrates a representative AFM height-image of a diblock copolymer film after solvent annealing with a mixture of cylinders parallel and perpendicular to the substrate pattern. The image size: 1 μm×1 μm and the Z range is 30 nm;

FIG. 10C illustrates a representative AFM height-image of a diblock copolymer film after solvent annealing with cylinders perpendicular to the substrate pattern. The image size: 1 μm×1 μm and the Z range is 30 nm;

FIG. 10D illustrates a representative AFM height-image of a diblock copolymer film prepared by morphology trapping using lowered temperature in conjunction with solvent annealing with cylinders perpendicular to the substrate pattern. The image size: 1 μm×1 μm and the Z range is 30 nm; and

FIG. 11 illustrates Ulva zoospore settlement studies as the density of spores per mm² for the control polymers and for the lower temperature and solvent annealing fabricated polystyrene-Nock-poly(methyl methacrylate) wafers. Each point is the mean from 90 counts on 3 replicate slides (30 on each wafer). Bars show 95% confidence limits.

### DETAILED DESCRIPTION OF THE INVENTION

Generally speaking, the embodiments described herein are directed to nanostructured AB diblock or higher copolymer films for inhibition of marine organism attachment to surfaces. As required, embodiments of the present invention are disclosed herein. However, the disclosed embodiments are merely exemplary, and it should be understood that the invention may be embodied in many various and alternative forms.

The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, nanostructured AB diblock or higher copolymer films for inhibition of marine organism attachment to surfaces are disclosed herein.

As used herein, the terms “about”, and “approximately” when used in conjunction with ranges of concentrations, temperatures or other physical or chemical properties or characteristics is meant to cover slight variations that may exist in the upper and lower limits of the ranges of properties/characteristics.

As used herein, “contacting” refers to the act of touching, making contact, or of bringing within immediate proximity.

As used herein, “coating” refers to a manufacturing process or preparation for applying an adherent layer to a surface. A coating can also be a layer of material that at least partially covers an underlying surface, such as an aquaculture cage, fishing nets, a boat hull or any other surface that requires an antifouling coating.

As used herein, “composition” refers to a mixture made of diblock copolymers and photo-initiators.

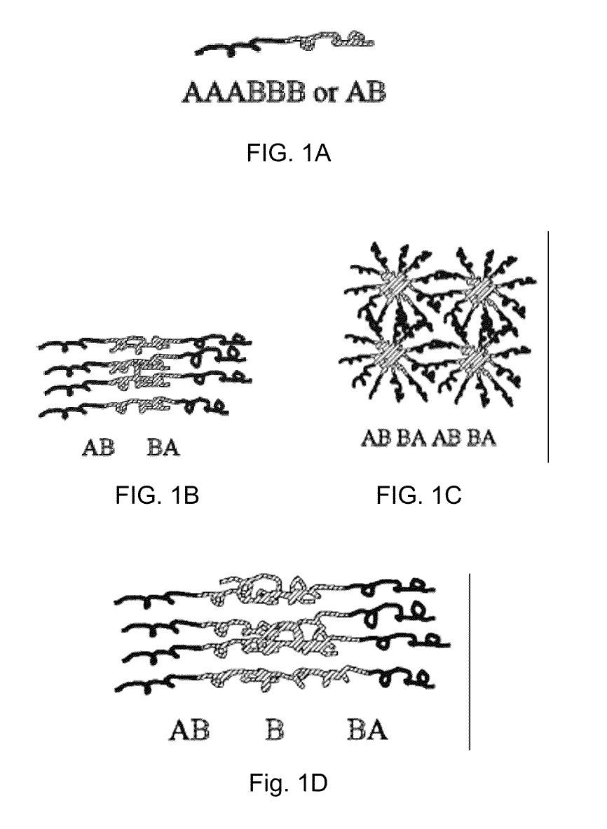

As used herein, “AB diblock copolymer” refers to a polymer that has two blocks A and B of different polymerized monomers linked by covalent bonds that can undergo phase separation as shown in FIG. 1A. The minimum value of the product of the degree of polymerization and the Flory-Huggins interaction parameter is preferably 10.5.

As used herein, “triblock copolymer” refers to a polymer that has three blocks of either two or three different polymerized monomers linked by covalent bonds that can undergo phase separation. If the copolymer has two different monomers they are ABA or BAB type, however for simplicity they are only called ABA type, while if they have three different monomers, they are called ABC type.

As used herein, “film” or “coating” refers to a thin material layer ranging from a few nanometers to several hundred nanometers.

As used herein, “biofouling” refers to the accumulation of living organisms such as diatoms, bacteria, algae, tubeworms or barnacles on surfaces immersed in seawater.

As used herein, “antifouling” refers to the prevention of marine organisms to settle on surfaces.

As used herein, the phrase “lower temperature treatment” or “lower temperature” means cooling the system below room temperature, 24° C., to just above the freezing point of the organic solvent used. For example, −94° C. for acetone and toluene or −65° C. for chloroform when these organic solvents are used.

As used herein, the phrase “temperature annealing” means raising the temperature of the block copolymer above the glass transition temperature (T_{g}) of each of the component blocks of the copolymer. For example, polystyrene-block-poly(methyl methacrylate) should be annealed at a temperature above 165° C. such as 170° C., since polystyrene has a T_{g} of 95° C. and poly(methyl methacrylate) has a T_{g} of 85° C. to 165° C.

Specific values and types of compounds such as solvents, photo-initiators or copolymers as well as specific embodiments of the invention described herein are for illustration only. They do not exclude other values and types as would be recognized by one skilled in the art.

The present invention provides both the materials and methods for obtaining diblock copolymer films in order to reduce biofouling of surfaces immersed in a marine environment. In one embodiment, the present invention provides compositions for marine paints and surface treatments that inhibit settlement of marine organisms.

In a preferred embodiment, the practice of the present invention prevents the attachment of marine organisms, such as algae zoospores, to surfaces immersed in a marine environment. Advantageously, the prevention of organisms' settlement is attained with the use of materials with a lower toxicity towards marine environments than current methods. Advantageously, this invention can be used to replace the metal biocides that are toxic and which have been, or will be, banned in the near future.

In a preferred embodiment of the present invention, AB diblock copolymer mixed/not mixed with a photo-initiator and UV cross-linked films are used as antifouling compositions to inhibit the attachment of marine organisms to surfaces immersed in a marine environment. The useful diblock copolymers according to the present invention include the ones in which the A and B blocks of the copolymer have different hydrophobicities and a minimum value of the product of the degree of polymerization and the Flory-Huggins interaction parameter of 10.5. The hydrophobicity of the blocks can be tailored to target either a specific organisms or a group of them. For example, algae avoid settling on hydrophilic surfaces and thus, for a coating, blocks will be chosen that have a different hydrophobicity and are hydrophilic such as polymers based on ethylene oxide. On the other hand, if the organism targeted avoids hydrophobic surfaces, then blocks that are hydrophobic may be chosen such as fluorinated polymers.

The method for making the coating involves dissolving an AB or higher block copolymer in an organic solvent to produce a solution, applying the solution to a surface where A and at least B self-assemble, as an AB or higher block copolymer on the surface into ordered structures to produce nanosized patterns on the surface. The solution is exposed to an initiator agent which is activated to cross-link the AB or higher block copolymer to form a coating. The cross-linked AB or higher block copolymer coating is then subjected to a lower temperature treatment in conjunction with solvent annealing to improve crystallinity of nanostructured domains of the coating. The A and B, or other blocks if present, each have a different hydrophobicity with the hydrophobicity of the blocks A and B, or other blocks if present, tailored to target either a specific organism or a group of organisms.

Preferred organic solvents include acetone, toluene and chloroform, or mixtures thereof. However it will be appreciated that other organic solvents may be used, for example benzene or tetrahydrofuran.

When the solvent is acetone, the lower temperature treatment includes subjecting the coating to a temperature in a range from about below 24° C. to a temperature just above about −94° C.

When the solvent is toluene, the lower temperature treatment includes subjecting the coating to a temperature in a range from about below 24° C. to a temperature just above about −94° C.

When the solvent is chloroform, the lower temperature treatment includes subjecting the coating to a temperature in a range from about below 24° C. to a temperature just above about −65° C.

It will be appreciated that in addition to photo-initiators mentioned above, the initiator may be any one or combination of radical initiators, cationic initiators, anionic initiator and ultraviolet light.

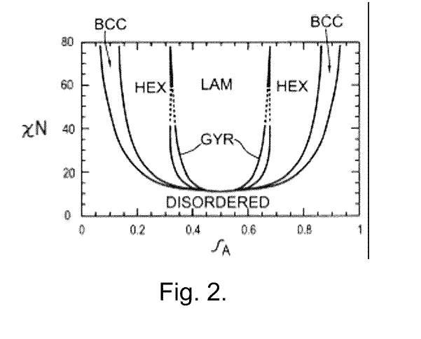

In a preferred embodiment of the present invention, an AB diblock copolymer self-assembles into ordered structures to produce nanosized patterns such as spheres, cylinders or lamella as shown in FIGS. 1B and 1C. The type of pattern depends on the total degree of polymerization (N), the Flory-Huggins interaction parameter (x) and the volume fraction of the blocks (f). Thus, by consulting the phase diagram for the diblock copolymers as shown in FIG. 2, values for the polymer parameters can be chosen to give a specific pattern. The pattern is also determined by the solvent in which the copolymer is dissolved, the substrate, the thickness of the coating, and the temperature. For example, if a copolymer is chosen that can self-assemble into a cylindrical pattern, the final pattern can be modified by changing the substrate. If the substrate attracts one of the blocks more than the other, then the final pattern will be lamellae or cylinders oriented parallel to the substrate and not cylinders orientated normal to the surface.

If the pattern is solvent annealed, then the solvent selectivity, the time of annealing, the humidity and the solvent evaporation rate will affect the final pattern. For example, if a copolymer is chosen that can self-assemble in a cylindrical pattern, the final pattern can be modified by changing the solvent selectivity. If the solvent attracts one of the blocks more than the other, then the final pattern will be lamella or cylinders oriented parallel to the substrate not cylinders orientated normal to the surface. Thus, different patterns can be obtained using either the same copolymer or different copolymers by varying some of the previous factors.

In a preferred embodiment of the invention the diblock copolymer can have a molecular weight from about 1,000 g/mol to about 1,000,000 g/mol. In a specific embodiment, the diblock copolymer molecular weight can be from 20,000 g/mol to 130,000 g/mol. Since length of each of the A and B blocks is proportional to the molecular weight of each of the A and B blocks length, the overall length of each of the A and B polymer chains and the overall size of the resulting pattern is proportional to the molecular weights of each of the A and B blocks. Thus a copolymer with a small molecular weight will produce a smaller pattern than a copolymer with a larger molecular weight. Another method to vary the pattern size is to add a homopolymer of either A or B or another AB copolymer to the AB diblock copolymer. This method will swell the existing pattern and thus allow a larger pattern to be obtained using a copolymer with a smaller initial molecular weight as shown in FIG. 1D. The molecular weight and concentration of the added polymer will affect the size of the pattern with a smaller polymer increasing the pattern less then a larger polymer.

Without limiting the scope of the present invention and without being limited to any theory, one explanation of why the present coatings exhibit such efficacy for prevention of fouling of surfaces by marine organisms contemplated by the inventors is that where A and B, or other blocks if present, each have respective molecular weights selected to give a length or size scale of the nanosized patterns which correspond to a length or size scale of one or more features of the specific organism, or a group of organisms, then this disrupts the ability of the specific organism or a group of organisms from adhering to the coated surface.

It will be appreciated that the present invention is not restricted to diblock copolymers, and may include, but is not restricted to, triblock or higher number of block copolymers. Triblock copolymers of both the ABA type and the ABC type can self-assemble and produce the same nanosized patterns as diblock copolymers. The pattern is also influenced by the same factors as diblock copolymers. Thus, they can be used as an alternative material to fabricate this antifouling coating.

As non-limiting examples, the coating may be made from a ABA triblock copolymer is selected from the group consisting of polystyrene-block-poly(2-vinyl pyridine)-block-polystyrene, poly(2-vinyl pyridine)-block-polystyrene-block-poly(2-vinyl pyridine), polystyrene-block-poly(4-vinyl pyridine)-block-polystyrene, poly(4-vinyl pyridine)-block-polystyrene-block-poly(4-vinyl pyridine), polystyrene-block-poly(methyl methacrylate)-block-polystyrene, poly(methyl methacrylate)-block-polystyrene-block-poly(methyl methacrylate), polystyrene-block-poly(ethylene oxide)-block-polystyrene, and poly(ethylene oxide)-block-polystyrene-block-poly(ethylene oxide).

The ABA triblock copolymer may have a molecular weight in a range from about 1,000 g/mol to about 1,000,000 g/mol.

Similarly, as non-limiting examples, the ABC triblock copolymer may be selected from the group consisting of poly(4-vinyl pyridine)-block-polystyrene-block-poly(2-vinyl pyridine), poly(2-vinyl pyridine)-block-polystyrene-block-poly(methyl methacrylate), poly(4-vinyl pyridine)-block-polystyrene-block-poly(methyl methacrylate), poly(2-vinyl pyridine)-block-polystyrene-block-poly(ethylene oxide), polystyrene-block-poly(ethylene oxide)-block-poly(methyl methacrylate).

The ABC triblock copolymer may have a molecular weight in a range from about 1,000 g/mol to about 1,000,000 g/mol.

In a preferred embodiment of the invention the diblock copolymer is neutral. The diblock copolymer can still be used successfully with a charge on up to 10% of the repeating units of the more hydrophilic block or blocks of the polymer.

Diblock copolymer chains can be modified with other chemical groups on the main polymer chain and/or on the side groups to target the desired organism/s. For example, algae do not like to settle on hydrophilic surfaces. If the coating is made of a diblock copolymer that is not effective enough to prevent the organism from attaching, the polymer can be chemically modified to be more hydrophilic by adding extra groups to the side chains such as groups based on ethylene oxide, which is hydrophilic.

The film obtained from the diblock copolymer mixed with the photo-initiator can be further treated by solvent vapor or temperature annealing to improve the nanostructured domains. In addition, the film will be subjected to UV treatment to induce photo cross-linking. This cross-linking leads to an improvement in mechanical properties, stability under water and increase in antifouling properties.

In a specific embodiment of the present invention, the diblock copolymer polystyrene-block-poly(2-vinyl pyridine) mixed with the photo-initiator benzophenone was used to fabricate copolymer films. The two blocks have different hydrophobicities, with polystyrene having a more hydrophobic character. Vapor solvent annealing and UV cross-linking was used on these films. These films have been found to retain their nanoscale pattern underwater and inhibit settlement of zoospores of the green alga Ulva.

The diblock copolymer films of the present invention undergo minimal surface reconstruction in a polar environment such as seawater and have antifouling properties towards marine organisms i.e. they inhibit settlement on the surface. These films can be used as antifouling coatings as a substitute for metal biocides paints in the surface protection of structures such as aquaculture cages, ship hulls and so on.

In a preferred embodiment of the present invention, the diblock copolymer in final morphology can be trapped by using a lower temperature treatment in conjunction with solvent vapor annealing. The temperature can be decreased to be below room temperature.

In a specific embodiment of the present invention, polystyrene-block-poly(methyl methacrylate) was used to fabricate copolymer films. The films have a cylindrically surface nanopattern after undergoing lower temperature treatment in conjunction with solvent vapor annealing.

The films of the present invention can be used as a coating and protecting layer for surfaces that require antifouling properties. The coatings can form either single layer coatings or multi-layer coatings.

The coating fabricated from the diblock copolymer can be used independently as an antifouling coating or in conjunction with a base layer of another polymer. This other polymer can be a random copolymer made of the same monomers as the diblock copolymer used in the coating.

A further embodiment of the present invention is directed towards a method of coating a surface that requires an antifouling coating with the present composition. A surface can be coated by contacting this surface with the composition by spin-coating, solvent-casting, brushing, immersing or pouring. The resulting layer will provide a protective coating from biofouling.

The surfaces that can be coated include, but are not limited to, surfaces made of nylon, silicon, polyester, polyethylene, steel or glass.

The amount of material used and the method of coating will result in coatings with various thicknesses. The coating can result in a top layer of 20 nm to 300 nm in thickness. Below 17 nm no reliable phase separation occurs and the film quality is poor.

### EXAMPLES

The following are examples that illustrate a method for the preparation of compositions of the present invention to fabricate films and testing the resulting films for antifouling properties. These examples are intended to illustrate the nature of such preparations are not intended to be limiting in the scope of applicable methods.

### Example 1

Fabrication of an Antifouling Coating Based on Polystyrene-block-Poly(2-vinyl pyridine)

### Materials and Methods

The hydroxy terminated polystyrene-block-poly(2-vinyl pyridine) diblock copolymer (Polymer Source) and the photo-initiator benzophenone (Sigma Aldrich) were used without further purification. Polystyrene-block-poly(2-vinyl pyridine) (polydispersity index 1.06, number average molecular weight for polystyrene 75,000 g/mol and for poly(2-vinyl pyridine) 21,000 g/mol) and benzophenone were mixed in toluene to give a 0.3 wt % solution with a 1:1 w/w ratio between copolymer and photo-initiator. Thin films were prepared by spin coating the toluene solutions onto piranha cleaned silicon substrates at 2000 rpm for 45 seconds. The thin films were solvent vapor annealed using toluene and chloroform (1/1 v/v) for 3 hours. Furthermore, the films were UV irradiated using a Mercury Arc Lamp (Pen-Ray, 90-0012-01) with an intensity of 15 mW/cm² for 5 minutes in air.

### Surface Characterization:

The surface topography was investigated using Atomic Force Microscopy (AFM). Measurements in air were performed with the AFM (Digital Instruments, Dimension 5000) operated in Tapping Mode and rectangular shaped silicon probes (NanoWorld, NCH) with resonance frequencies in the range 280-320 kHz and a spring constant of 40 N/m. All measurements in solution were obtained using the Molecular Force Probe AFM (Asylum Research, MFP-3D) operated in the iDrive mode and V-shaped, silicon nitride cantilevers (Asylum Research, AR-iDrive) with a spring constant of 100 pN/nm.

The thickness of the films was obtained using a custom made ellipsometer with a laser light source.

The surface energy of the films was quantified by determining the advancing contact angles of water drops on these films. A contact angle meter (KSV Instruments, Cam101) was used with ultrapure water (Mili-Q 18 MΩ).

The surface composition of these films was obtained using X-ray Photoelectron Spectroscopy. An ESCA (Phi, 5500) system with an Al Kα (1486.7 eV) monochromated X-ray source was used to obtain the spectra at a take-off angle of 45°.

### Results and Discussion

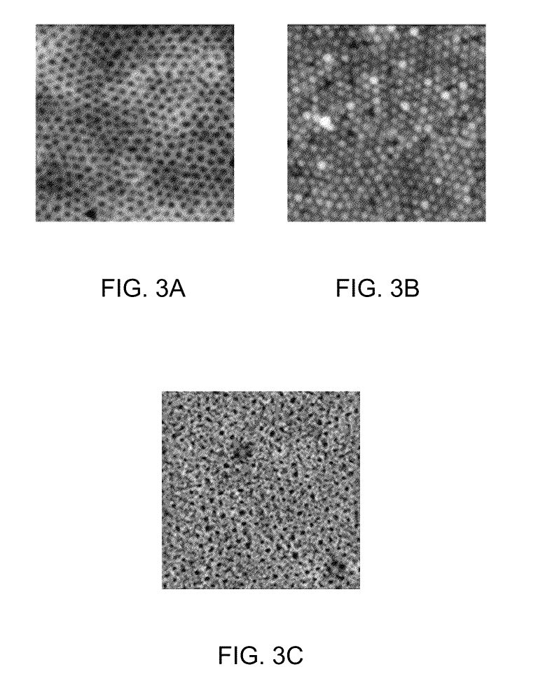

Films made from polystyrene-block-poly(2-vinyl pyridine) mixed with benzophenone by spin-coating and after solvent annealing displayed nanosize cylindrical domains as can be seen in FIG. 3A. The brighter areas in the image correspond to the polystyrene matrix, while the darker areas correspond to the poly(2-vinyl pyridine) domains. The contact angle of these films is 94±3°.

The films after photo cross-linking are shown in FIG. 3B. The brighter areas in the image correspond to the poly(2-vinyl pyridine) domains, while the darker areas correspond to the polystyrene matrix. In this case, a micelle-type structure is observed and the contact angle decreases to 61±3°. This indicates that these new films are more hydrophilic than the non-cross-linked films. The UV irradiation helps to introduce more oxygen-containing surface groups as was confirmed by X-ray Photoelectron Spectroscopy.

Pattern retention was investigated by immersing these films in water. The micelle-like structure changed into cylinders orientated normal to the surface when placed in water as can be seen in FIG. 3C. The brighter areas in the image correspond to the polystyrene matrix, while the darker areas correspond to the poly(2-vinyl pyridine) domains. Afterwards, these cylindrical domains do not undergo further restructuring. The contact angle of these films is about 64±4°, which indicates that water does not infiltrate significantly into the film. Thus, the UV cross-linking stabilizes the surface groups.

The polystyrene-block-poly(2-vinyl pyridine) films used in this example are neutral, photo cross-linked and not quaternized. Related polymers were used in the Ober patent publication (Ober et al. [2007] US Patent 20070106040A1), however these polymers were quaternized more than 10%, charged and had groups that were at least partially fluorinated. Due to a lack of charge the polystyrene-block-poly(2-vinyl pyridine) are easy to work with and fabricate films as compared to the charged copolymers. Furthermore, the polystyrene-block-poly(2-vinyl pyridine) films are not mobile and become stable in water with minimal change in contact angle as compared to the charge copolymer that are mobile, reorganize in water and have a large contact angle hysteresis.

The polystyrene-block-poly(2-vinyl pyridine) and polystyrene-block-poly(4-vinyl pyridine) copolymers used in the cell-surface interaction studies were mobile and could reconstruct when immersed in water (Khor et al. [2007] Biomacromolecules 8: 1530-1540). These films were not cross-linked. In addition, the patterns fabricated were not the well-defined classical ordered structures.

### Conclusion

The fabrication of films using a diblock copolymer mixed with a photo-initiator solution by spin-coating was successful. The results show that the nanoscale pattern of these films is preserved in water. Thus, an antifouling coating can be prepared and used to coat surfaces by using this method.

It will be understood that solvent-casting, brushing, immersing or pouring over the desired surface the composition are viable methods. This example is for illustration purposes only.

### Example 2

### Inhibition of Zoospores of the Green Alga Ulva

### Materials and Methods:

The hydroxy terminated polystyrene-block-poly(2-vinyl pyridine) diblock copolymer (Polymer Source, polydispersity index: 1.06, number average molecular weight for polystyrene: 75,000 g/mol and for poly(2-vinyl pyridine): 21,000 g/mol) and the photo-initiator benzophenone (Sigma Aldrich) were used without further purification. Polystyrene-block-poly(2-vinyl pyridine) and benzophenone were mixed in toluene to give a 0.3 wt % solution with a 1:1 w/w ratio between copolymer and photo-initiator. Thin films were prepared by spin coating the toluene solutions onto piranha cleaned silicon substrates at 2000 rpm for 45 seconds. The thin films were solvent vapor annealed using toluene and chloroform (1/1 v/v) for 3 hours. Furthermore, the films were UV irradiated using a Mercury Arc Lamp (Pen-Ray, 90-0012-01) with an intensity of 15 mW/cm² for 5 minutes in air.

Polystyrene (Polymer Source, polydispersity index: 1.05, the number average molecular weight: 131,000 g/mol), poly(2-vinyl pyridine) (Polymer Source, polydispersity index: 1.09, the number average molecular weight: 22,000 g/mol), polystyrene-co-2-vinyl pyridine random copolymer (Polymer Source, polydispersity index: 1.7, the number average molecular weight: 75,000 g/mol) and hydroxy terminated polystyrene-block-poly(2-vinyl pyridine) diblock copolymer (Polymer Source, polydispersity index: 1.06, number average molecular weight for polystyrene: 75,000 g/mol and for poly(2-vinyl pyridine): 21,000 g/mol) were used without further purification. Thin films were prepared by spin coating 0.3 wt % toluene solutions of these polymers on piranha cleaned silicon substrates at 2000 rpm for 45 seconds. The thin films made from hydroxy terminated polystyrene-block-poly(2-vinyl pyridine) diblock copolymer were solvent vapor annealed using toluene and chloroform (1/1 v/v) for 3 hours.

### Ulva Zoospore Settlement Assay

Attachment experiments were performed using zoospores released from mature Ulva linza plants using standard methods (Callow et al. [1997] J. Phycol. 33: 938-974). In brief, zoospores were settled in individual dishes containing 10 ml of zoospore suspension, in the dark at ˜20° C. Each dish contained one silicon wafer (size 2.5 cm×2.5 cm) coated in polymer. After 60 minutes the slides were washed in seawater to remove unsettled zoospores. Slides were fixed using 2.5% glutaraldehyde in seawater. The density of zoospores attached to the surface was counted on each of the replicate silicon wafers using an image analysis system (Imaging Associates Ltd.) attached to an epifluorescence microscope (Zeiss, Aksioskop 2). Spores were visualised by autofluorescence of chlorophyll. Counts were made for 30 fields of view (each 0.17 mm²) on each wafer.

### Results and Discussion

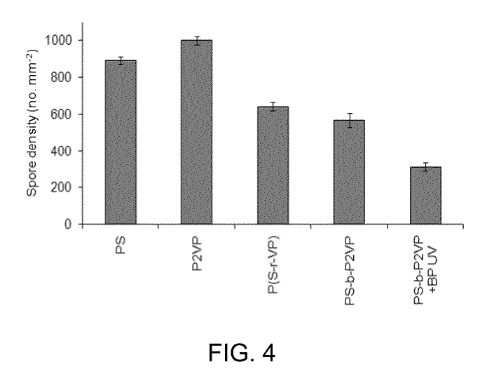

The density of zoospores settled (attached) on a variety of polymers on silicon wafers can be seen in FIG. 4. A one-way ANOVA showed that all the comparisons are significantly different. The settlement density of spores was greatest on the two control surfaces i.e. polystyrene and poly(2-vinyl pyridine). The lowest settlement density was on the polystyrene-block-poly(2-vinyl pyridine) and benzophenone films after UV treatment and the polystyrene-block-poly(2-vinyl pyridine) surfaces, both of which were comprised of cylindrical patterns. The chemical and topographical heterogeneity of these surfaces may be working independently or in tandem to discourage spore settlement.

The significantly lower settlement on the polystyrene-block-poly(2-vinyl pyridine) and benzophenone films after UV treatment compared to the polystyrene-block-poly(2-vinyl pyridine) films may reflect the higher degree of stability in water of the cylindrical pattern on the UV treated samples. The polystyrene-block-poly(2-vinyl pyridine) films lose their cylindrical pattern after 1.5 hours immersion in water. The different hydrophobicity between the cylindrical portion of the pattern and the matrix may deter spores, which would have settled on a surface with uniform hydrophobicity. Similarly, the nanoscale roughness may act as a deterrent if the spores prefer a smoother surface. Alternatively it is possible that all of this heterogeneity simply confuses the spore by sending it conflicting signals.

The polystyrene-block-poly(2-vinyl pyridine) films in addition to stability and good pattern retention also prevents the settlement of zoospores. The copolymers in Ober's patent (Ober et al. [2007] US Patent 20070106040A1) which reconstruct underwater have a high zoospore settlement. The settlement density of Ulva alga zoospores was high due to favorable electrostatic interactions between the negatively charged zoospores and the positively charged copolymers.

The cell-surface interaction studies using polystyrene-block-poly(2-vinyl pyridine) and polystyrene-block-poly(4-vinyl pyridine) copolymers did not investigate the effect of these copolymers on marine organisms (Khor et al. [2007] Biomacromolecules 8: 1530-1540). The fibroblast and mesenchymal progenitor cells preferred the wormlike patterns for adhesion and proliferation.

### Conclusion

Nanopatterned films affect the settlement response of zoospores of Ulva. Spore settlement density was greatly reduced on the cylindrical patterned UV cross-linked polystyrene-block-poly(2-vinyl pyridine) and benzophenone films. Thus, these films can be used as an antifouling coating.

### Example 3

Fabrication and Testing of an Antifouling Coating Based on Polystyrene-block-Poly(methyl methacrylate)

### Materials and Methods:

Polystyrene-block-poly(methyl methacrylate) diblock copolymer (Polymer Source) was used without further purification. Polystyrene-block-poly(methyl methacrylate) (polydispersity index 1.10, number average molecular weight for polystyrene 130,000 g/mol and for poly(methyl methacrylate) 133,000 g/mol) was dissolved in toluene to give a 1 wt % solution. Thin films were prepared by spin coating the toluene solution onto piranha cleaned silicon substrates at 2000 rpm for 45 seconds. The thin films were solvent vapor annealed using acetone (1/1 v/v) for 5 hours.

### Surface Characterization:

The surface topography was investigated using Atomic Force Microscopy (AFM). Measurements in air were performed with the AFM (Digital Instruments, Dimension 5000) operated in Tapping Mode and rectangular shaped silicon probes (NanoWorld, NCH) with resonance frequencies in the range 280-320 kHz and a spring constant of 40 N/m. All measurements in solution were obtained using the Molecular Force Probe AFM (Asylum Research, MFP-3D) operated in the iDrive mode and V-shaped, silicon nitride cantilevers (Asylum Research, AR-iDrive) with a spring constant of 100 pN/nm.

The surface energy of the films was quantified by determining the advancing contact angles of water drops on these films. A contact angle meter (KSV Instruments, Cam101) was used with ultrapure water (Mili-Q 18 MΩ).

### Ulva Zoospore Settlement Assay

Attachment experiments were performed using zoospores released from mature Ulva linza plants using standard methods (Callow et al. [1997] J. Phycol. 33: 938-974). In brief, zoospores were settled in individual dishes containing 10 ml of zoospore suspension, in the dark at ˜20° C. Each dish contained one silicon wafer (size 2.5 cm×2.5 cm) coated in polymer. After 60 minutes the slides were washed in seawater to remove unsettled zoospores. Slides were fixed using 2.5% glutaraldehyde in seawater. The density of zoospores attached to the surface was counted on each of the replicate silicon wafers using an image analysis system (Imaging Associates Ltd.) attached to an epifluorescence microscope (Zeiss, Aksioskop 2). Spores were visualised by autofluorescence of chlorophyll. Counts were made for 30 fields of view (each 0.17 mm²) on each wafer.

### Results and Discussion

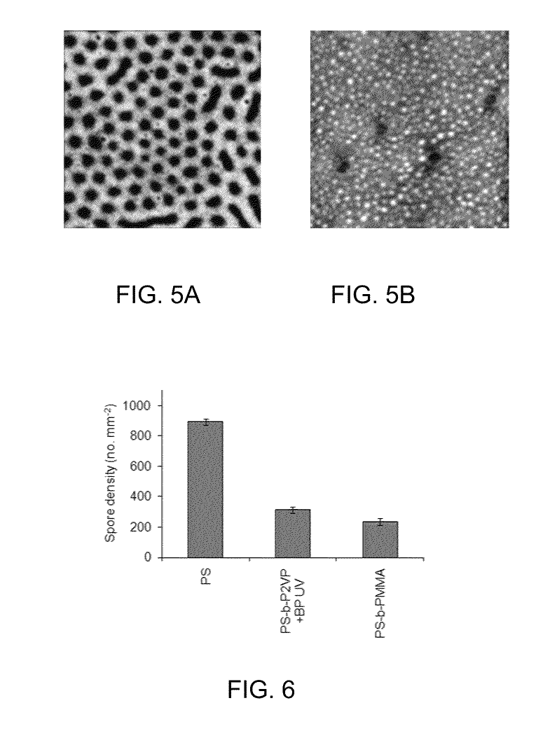

Films made from polystyrene-block-poly(methyl methacrylate) after solvent annealing displayed nanosize cylindrical domains as can be seen in FIG. 5A. The brighter areas in the image correspond to the polystyrene matrix, while the darker areas correspond to the poly(methyl methacrylate) domains. The contact angle of these films is 84±3°.

Pattern retention was investigated by immersing these films in water. When immersed in water, the diblock copolymer film swelled after 1 hour and the patterned is almost gone after 1.5 hours as shown in FIG. 5B. The brighter areas in the image correspond to the poly(methyl methacrylate) domains, while the darker areas correspond to the polystyrene matrix. The contact angle of these films is about 80±3° and decreases to 70±3° after 8 days in water. The copolymer film is mobile and undergoes surface reorganization.

The density of zoospores settled (attached) on a variety of polymers on silicon wafers is shown in FIG. 6. A one-way ANOVA showed that all the comparisons are significantly different. The settlement density of spores was low on the polystyrene-block-poly(2-vinyl pyridine) and benzophenone films after UV treatment and slightly lower on the polystyrene-block-poly(methyl methacrylate) surfaces, both of which were comprised of cylindrical patterns. In this case too, the chemical and topographical heterogeneity of these surfaces may be working independently or in tandem to discourage spore settlement.

Cross-linking of polystyrene-block-poly(methyl methacrylate) should improve the water stability and decrease the diblock copolymer mobility. In addition, if the dilbock copolymer is not prone to surface reorganization it is expected for an increase in preventing zoospore settlement. Thus, better antifouling properties will be achieved similar to the case for non-cross-linked polystyrene-block-poly(2-vinyl pyridine) and UV cross-linked polystyrene-block-poly(2-vinyl pyridine) and benzophenone.

### Conclusion

Polystyrene-block-poly(methyl methacrylate) diblock copolymer was successful used to fabricate nanopatterned films by spin-coating. The diblock copolymer has antifouling properties even if this copolymer reorganizes in water. Cross-linked is expected to increase the pattern retention in water and thus stop the reorganization as well as increase the antifouling properties.

### Example 4

Fabrication and Testing of an Antifouling Coatings based on Polystyrene-block-Poly(2-vinyl pyridine) and Polystyrene-block-Poly(methyl methacrylate) on Nylon

### Materials and Methods

A type 6,6 Nylon 101 sheet (Thyssenkrupp Materials NA) was cut and dissolved in formic acid (Fluka) to give a 0.3 wt % solution. Thin films were prepared by spin coating the formic acid solution onto piranha cleaned silicon substrates at 4000 rpm for 45 seconds.

The hydroxy terminated polystyrene-block-poly(2-vinyl pyridine) diblock copolymer (Polymer Source) and the photo-initiator benzophenone (Sigma Aldrich) were used without further purification. Polystyrene-block-poly(2-vinyl pyridine) (polydispersity index 1.06, number average molecular weight for polystyrene 75,000 g/mol and for poly(2-vinyl pyridine) 21,000 g/mol) and benzophenone were mixed in toluene to give a 0.3 wt % solution with a 1:1 w/w ratio between copolymer and photo-initiator. Thin films were prepared by spin coating the toluene solutions onto nylon films at 2000 rpm for 45 seconds. The thin films were solvent vapor annealed using toluene and chloroform (1/1 v/v) for 2 hours. Furthermore, the films were UV irradiated using a Mercury Arc Lamp (Pen-Ray, 90-0012-01) with an intensity of 15 mW/cm² for 5 minutes in air.

Polystyrene-block-poly(methyl methacrylate) diblock copolymer (Polymer Source) was used without further purification. Polystyrene-block-poly(methyl methacrylate) (polydispersity index 1.10, number average molecular weight for polystyrene 130,000 g/mol and for poly(methyl methacrylate) 133,000 g/mol) was dissolved in toluene to give a 1 wt % solution. Thin films were prepared by spin coating the toluene solution onto nylon films at 2000 rpm for 45 seconds. The thin films were solvent vapor annealed using acetone (1/1 v/v) for 2 hours.

Polystyrene (Polymer Source, polydispersity index: 1.05, the number average molecular weight: 131,000 g/mol), poly(2-vinyl pyridine) (Polymer Source, polydispersity index: 1.09, the number average molecular weight: 22,000 g/mol), polystyrene-co-2-vinyl pyridine random copolymer (Polymer Source, polydispersity index: 1.7, the number average molecular weight: 75,000 g/mol) and hydroxy terminated polystyrene-block-poly(2-vinyl pyridine) diblock copolymer (Polymer Source, polydispersity index: 1.06, number average molecular weight for polystyrene: 75,000 g/mol and for poly(2-vinyl pyridine): 21,000 g/mol) were used without further purification. Thin films were prepared by spin coating 0.3 wt % toluene solutions of these polymers onto nylon at 2000 rpm for 45 seconds. The thin films made from hydroxy terminated polystyrene-block-poly(2-vinyl pyridine) diblock copolymer were solvent vapor annealed using toluene and chloroform (1/1 v/v) for 3 hours.

### Surface Characterization:

The surface topography was investigated using Atomic Force Microscopy (AFM). Measurements in air were performed with the AFM (Digital Instruments, Dimension 5000) operated in Tapping Mode and rectangular shaped silicon probes (NanoWorld, NCH) with resonance frequencies in the range 280-320 kHz and a spring constant of 40 N/m. All measurements in solution were obtained using the Molecular Force Probe AFM (Asylum Research, MFP-3D) operated in the iDrive mode and V-shaped, silicon nitride cantilevers (Asylum Research, AR-iDrive) with a spring constant of 100 pN/nm.

The surface energy of the films was quantified by determining the advancing contact angles of water drops on these films. A contact angle meter (KSV Instruments, Cam101) was used with ultrapure water (Mili-Q 18 MΩ).

### Ulva Zoospore Settlement Assay

Attachment experiments were performed using zoospores released from mature Ulva linza plants using standard methods (Callow et al. [1997] J. Phycol. 33: 938-974). In brief, zoospores were settled in individual dishes containing 10 ml of zoospore suspension, in the dark at ˜20° C. Each dish contained one silicon wafer (size 2.5 cm×2.5 cm) coated in polymer. After 60 minutes the slides were washed in seawater to remove unsettled zoospores. Slides were fixed using 2.5% glutaraldehyde in seawater. The density of zoospores attached to the surface was counted on each of the replicate silicon wafers using an image analysis system (Imaging Associates Ltd.) attached to an epifluorescence microscope (Zeiss, Aksioskop 2). Spores were visualised by autofluorescence of chlorophyll. Counts were made for 30 fields of view (each 0.17 mm²) on each wafer.

### Results and Discussion

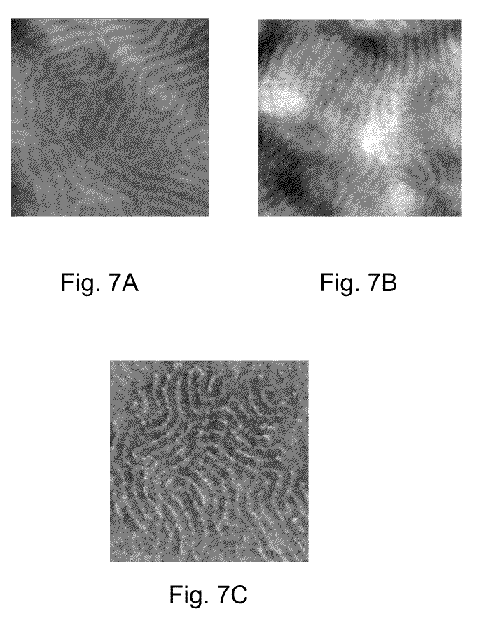

Films made from polystyrene-block-poly(2-vinyl pyridine) mixed with benzophenone by spin-coating and after solvent annealing displayed nanosize cylindrical domains parallel to the surface as can be seen in FIG. 7A. The darker areas in the image correspond to the polystyrene matrix, while the brighter areas correspond to the poly(2-vinyl pyridine) domains. The contact angle of these films is 86±3°.

The films after photo cross-linking are shown in the height image in FIG. 7B. The brighter areas correspond to the poly(2-vinyl pyridine) domains, while the darker areas in the image correspond to the polystyrene matrix. The contact angle decreases to 43±3°. This indicates that these new films are more hydrophilic than the non-cross-linked films.

Pattern retention was investigated by immersing these films in water. The cylinders orientated parallel to the surface are retained when placed in water as can be seen in the phase image in FIG. 7C. The darker areas in the image correspond to the polystyrene matrix, while the brighter areas correspond to the poly(2-vinyl pyridine) domains. Afterwards, these domains do not undergo further restructuring.

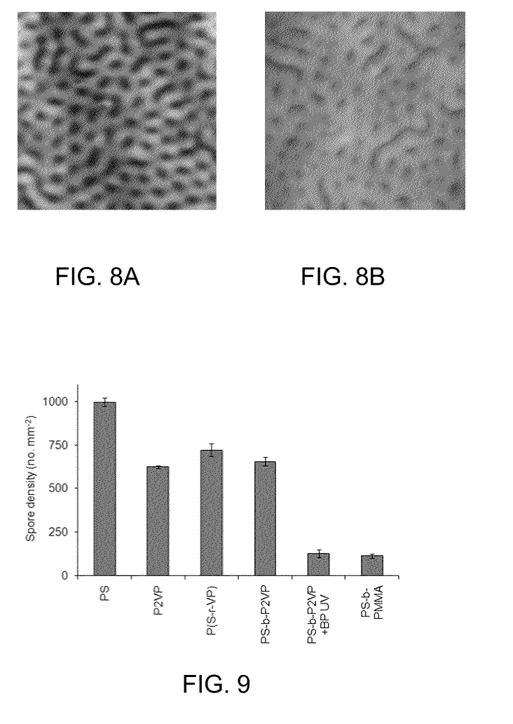

Films made from polystyrene-block-poly(methyl methacrylate) after solvent annealing displayed nanosize cylindrical domains as can be seen in FIG. 8A. The brighter areas in the image correspond to the polystyrene matrix, while the darker areas correspond to the poly(methyl methacrylate) domains. The contact angle of these films is 71±3°.

Pattern retention was investigated by immersing these films in water. When immersed in water, the diblock copolymer film retained the pattern as shown in FIG. 8B. The brighter areas in the image correspond to the polystyrene matrix, while the darker areas correspond to the poly(methyl methacrylate) domains.

The density of zoospores settled (attached) on a variety of polymers onto nylon can be seen in FIG. 9. The settlement density of spores was greatest on the control surfaces. The lowest settlement density was on the polystyrene-block-poly(2-vinyl pyridine) and benzophenone films after UV treatment and the polystyrene-block-poly(methyl methacrylate) surfaces, both of which were comprised of cylindrical patterns. The chemical and topographical heterogeneity of these surfaces may be working independently or in tandem to discourage spore settlement.

The significantly lower settlement on the polystyrene-block-poly(2-vinyl pyridine) and benzophenone films after UV treatment compared to the polystyrene-block-poly(2-vinyl pyridine) films may reflect the higher degree of stability in water of the cylindrical pattern on the UV treated samples. The polystyrene-block-poly(2-vinyl pyridine) films lose their cylindrical pattern after 1.5 hours immersion in water. The different hydrophobicity between the cylindrical portion of the pattern and the matrix may deter spores, which would have settled on a surface with uniform hydrophobicity. Similarly, the nanoscale roughness may act as a deterrent if the spores prefer a smoother surface. Alternatively it is possible that all of this heterogeneity simply confuses the spore by sending it conflicting signals.

### Conclusion

The fabrication of films using a polystyrene-block-poly(2-vinyl pyridine) mixed with a photo-initiator solution or a polystyrene-block-poly(methyl methacrylate) solution by spin-coating onto a nylon surface was successful. The results show that the nanoscale pattern of these films is preserved in water. Spore settlement density was lowest on the cylindrical patterned UV cross-linked polystyrene-block-poly(2-vinyl pyridine) and benzophenone films and on the polystyrene-block-poly(methyl methacrylate). Thus, an antifouling coating can be prepared and used to coat surfaces by using this method.

### Example 5

Morphology Trapping of Polystyrene-block-Poly(methyl methacrylate) Thin Films Using Lower Temperature in Conjunction With Solvent Vapor Annealing

### Materials and Methods:

Polystyrene-block-poly(methyl methacrylate) diblock copolymer (Polymer Source) was used without further purification. Polystyrene-block-poly(methyl methacrylate) (polydispersity index 1.10, number average molecular weight for polystyrene 130,000 g/mol and for poly(methyl methacrylate) 133,000 g/mol) was dissolved in toluene to give a 1 wt % solution. Thin films were prepared by spin coating the toluene solution onto piranha cleaned silicon substrates at 2000 rpm for 45 seconds. The thin films were placed in a chamber at 2° C. and solvent vapor annealed in acetone for 2 hours. The films were taken out of the chamber and brought back to room temperature, 24° C. Some of the thin films were only solvent vapor annealed using acetone (1/1 v/v) for 2 hours at room temperature.

### Surface Characterization:

The surface topography was investigated using Atomic Force Microscopy (AFM). Measurements in air were performed with the AFM (Digital Instruments, Dimension 5000) operated in Tapping Mode and rectangular shaped silicon probes (NanoWorld, NCH) with resonance frequencies in the range 280-320 kHz and a spring constant of 40 N/m.

The surface energy of the films was quantified by determining the advancing contact angles of water drops on these films. A contact angle meter (KSV Instruments, Cam101) was used with ultrapure water (Mili-Q 18 MΩ).

### Results and Discussion

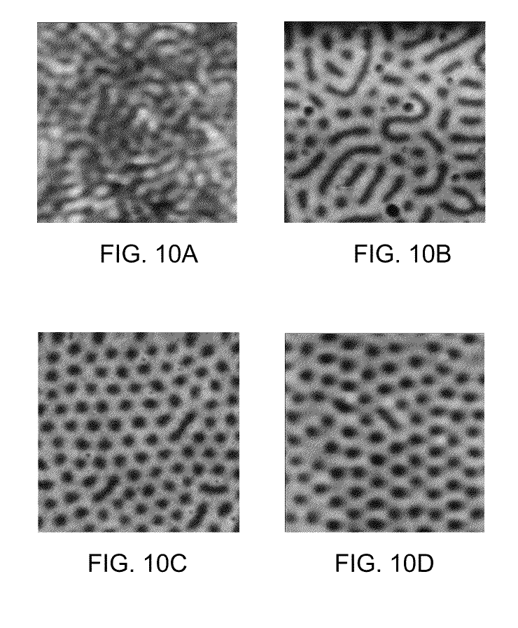

Films made from polystyrene-block-poly(methyl methacrylate) before solvent annealing display a worm-like morphology as shown in FIG. 10A. After solvent annealing at room temperature 21% of 50 samples had no pattern, 73% of samples had a mixture of cylinders parallel and perpendicular to the substrate, as shown in FIG. 10B, while only 6% of samples had a pattern of cylinders perpendicular to the substrate, as shown in FIG. 10C. The brighter areas in the image correspond to the polystyrene matrix, while the darker areas correspond to the poly(methyl methacrylate) domains. The contact angle of these films is 84±3°.

When the thin films were placed in a chamber at 2° C. and solvent vapor annealed in acetone, 38% of 30 samples had cylinders perpendicular to the substrate, as shown in FIG. 10D, while 62% had a mixture of cylinders parallel and perpendicular to the substrate. The brighter areas in the image correspond to the polystyrene matrix, while the darker areas correspond to the poly(methyl methacrylate) domains. The advancing water contact angle stayed the same at 84±3°.

As the temperature is decreased the Flory-Huggins interaction parameter and the polymer-solvent interaction parameter do not change significantly. However, at the lower temperature, the rate of acetone evaporation decreases, and there are fewer solvent molecules present in the chamber. The saturated vapor pressure for acetone decreases three-fold, from 219 mmHg to 77 mmHg, when the temperature is decreased from 24 to 2° C. The expected maximum volume concentration in the polymer decreases from 13 cm³ of gas/cm³ of polymer at 24° C. to 4.5 cm³ of gas/cm³ of polymer at 2° C., leading to a slower chain mobility at 2° C. There is a 6-10% more coverage of PMMA at 24° C. than at 2° C. The number of cylinders per μm² at 24° C. is also higher that at 2° C. by 14% on average. The size of the cylinder domains does not vary; however the PS-b-PMMA interfacial length per μm² at 24° C. is 25% higher than at 2° C.

In addition, after 2 hours in the case of lower temperature morphology trapping, only 16% of the acetone is lost, while for the room temperature solvent annealing case, 30% of the acetone is lost. The chambers are not a closed system and the acetone can escape into the atmosphere.

The slower polymer mobility, kinetics, and less dissolved acetone in the film cause the morphology at 2° C. to be predominantly cylinders in comparison to 24° C. The morphology of the films is trapped in this cylindrical pattern. It is only a matter of time that the morphology eventually evolves to entirely cylinders parallel to the substrate, also called lamellar. The evolution of the overall surface morphology is ultimately driven by thermodynamics from cylinders to lamellar, the local structure around each one cylinder is likely to reside in a local free energy minimum. The time scale of the local restructuring around single cylinders should be considerably faster than the global restructuring rate, as the global restructuring that involves joining of separated cylinder to form lamellar structure requires significant energy barrier crossing. Hence, it is reasonable to explain the size of individual cylinders by thermodynamic considerations as they are in local equilibrium; while explaining the global morphology by kinetics: since the system has not reached a global minimum, the rate as well as the time allowed for the system to evolve will determine its morphological outcome.

### Conclusion

Polystyrene-block-poly(methyl methacrylate) diblock copolymer was successful used to fabricate nanopatterned films by spin-coating. Morphology trapping by lowered temperature in conjunction with solvent annealing highly increases the number of samples fabricated that display the cylinders perpendicular to the substrate pattern.

### Example 6

Testing of an Antifouling Coating Fabricated by Morphology Trapping of Polystyrene-block-Poly(methyl methacrylate) Thin Films Using Lower Temperature in Conjunction With Solvent Vapor Annealing

### Materials and Methods:

Polystyrene-block-poly(methyl methacrylate) diblock copolymer (Polymer Source) was used without further purification. Polystyrene-block-poly(methyl methacrylate) (polydispersity index 1.09, number average molecular weight for polystyrene 160,000 g/mol and for poly(methyl methacrylate) 160,000 g/mol) was dissolved in toluene to give a 1 wt % solution. Thin films were prepared by spin coating the toluene solution onto piranha cleaned silicon substrates at 2000 rpm for 45 seconds. The thin films were placed in a chamber at 2° C. and solvent vapor annealed in acetone for 2 hours. The films were taken out of the chamber and brought back to room temperature, 24° C.

Polystyrene (Polymer Source, polydispersity index: 1.05, the number average molecular weight: 131,000 g/mol), poly(2-vinyl pyridine) (Polymer Source, polydispersity index: 1.09, the number average molecular weight: 22,000 g/mol) and polystyrene-co-methyl methacrylate random copolymer (Polymer Source, polydispersity index: 1.7, the number average molecular weight: 102,000 g/mol) were used without further purification. Thin films were prepared by spin coating 1 wt % toluene solutions of these polymers on piranha cleaned silicon substrates at 2000 rpm for 45 seconds.

### Ulva Zoospore Settlement Assay

Attachment experiments were performed using zoospores released from mature Ulva linza plants using standard methods (Callow et al. [1997] J. Phycol. 33: 938-974). In brief, zoospores were settled in individual dishes containing 10 ml of zoospore suspension, in the dark at ˜20° C. Each dish contained one silicon wafer (size 2.5 cm×2.5 cm) coated in polymer. After 60 minutes the slides were washed in seawater to remove unsettled zoospores. Slides were fixed using 2.5% glutaraldehyde in seawater. The density of zoospores attached to the surface was counted on each of the replicate silicon wafers using an image analysis system (Imaging Associates Ltd.) attached to an epifluorescence microscope (Zeiss, Aksioskop 2). Spores were visualised by autofluorescence of chlorophyll. Counts were made for 30 fields of view (each 0.17 mm²) on each wafer.

### Results and Discussion

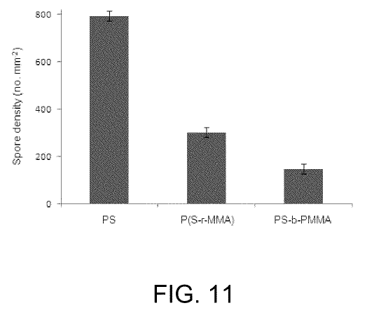

The density of zoospores settled (attached) on a variety of polymers on silicon wafers is shown in FIG. 11. The settlement density of spores was greatest on the polystyrene control surfaces. The polystyrene-co-methyl methacrylate random copolymer had an intermediate spore settlement. The random copolymer film has both polymer blocks at the surface; however, the blocks do not form a pattern. Thus, it is expected to have a higher settlement than a patterned surface, but a lower settlement then a pure homopolymer surface since two different chemistries are present. The lowest settlement density was on the polystyrene-block-poly(methyl methacrylate) surfaces, which had the cylindrical nanopattern. The chemical and topographical heterogeneity of these surfaces may be working independently or in tandem to discourage spore settlement.

### Conclusion

Polystyrene-block-poly(methyl methacrylate) diblock copolymer was successfully used to fabricate nanopatterned films by spin-coating. The films were prepared by morphology trapping by lower temperature in conjunction with solvent annealing. The diblock copolymer coating has antifouling properties.

The examples and embodiments described herein are for illustrative purposes only. Modifications or changes in light thereof will be suggested to persons skilled in the art and are to be included within the spirit and purview of this application.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

Therefore what is claimed is:

1. A method of applying an antifouling coating to a surface for preventing marine biofouling in marine environments, comprising:
dissolving an AB or higher block copolymer in an organic solvent to produce a solution, applying the solution to a surface where A and at least B self-assemble, as an AB or higher block copolymer on the surface into ordered structures to produce nanosized patterns on the surface, exposing said solution to an initiator agent and activating the initiator agent to cross-link the AB or higher block copolymer to form a coating, subjecting said cross-linked AB or higher block copolymer coating to a lower temperature treatment in conjunction with solvent annealing to improve crystallinity of nanostructured domains of the coating, where A and B or other blocks if present each have a different hydrophobicity with the hydrophobicity of the blocks A and B or other blocks if present tailored to target either a specific organism or a group of organisms.

2. The method according to claim 1 wherein said initiator agent is any one or combination of radical initiators, cationic initiators, anionic initiator, and ultraviolet light.

3. The method according to claim 2 wherein the initiator agent is a photo-initiator is selected from the group consisting of benzophenone, benzoin ethyl ether, and [1,12-dodecanediylbis(oxy-4,1-phenylene)][bis[phenylmethanone].

4. The method according to claim 1 wherein the organic solvent is selected from the group consisting of acetone, toluene, benzene, chloroform and tetrahydrofuran.

5. The method according to claim 1 where the solution is applied to the surface by spin-coating, solvent-casting, brushing, immersing, spraying or pouring the solution over the surface.

6. The method according to claim 1 wherein the solution is applied to the surface in sufficient quantity to give a coating thickness in a range from about 20 nm to about 300 nm.

7. The method according to claim 1 including any one or combination of subjecting said coating to solvent vapor annealing and temperature annealing to improve crystallinity of nanostructured domains of the coating.

8. The method according to claim 1 including irradiating the cross-linked AB or higher block copolymer coating with ultraviolet light in order to improve stability and mechanical properties of the coating.

9. The method according to claim 1 wherein said AB or higher block copolymer is an AB diblock copolymer.

10. The method according to claim 1 wherein said AB or higher block copolymer is ABA triblock copolymer.

11. The method according to claim 1 wherein said AB or higher block copolymer is ABC triblock copolymer.

12. The method according to claim 1 wherein a minimum value of product of a degree of polymerization and a Flory-Huggins interaction parameter is at least 10.5.

13. The method according to claim 1 wherein any or all the blocks of the AB or higher block copolymer can be neutral or exhibit quaternization of up to 10% of the repeating units that have pyridine containing substituents.

14. The method according to claim 9 wherein the AB diblock copolymer is selected from the group consisting of polystyrene-block-poly(2-vinyl pyridine), polystyrene-block-poly(4-vinyl pyridine), polystyrene-block-poly(methyl methacrylate), and polystyrene-block-poly(ethylene oxide).

15. The method according to claim 14 wherein the AB diblock copolymer has a molecular weight in a range from about 1,000 g/mol to about 1,000,000 g/mol.

16. The method according to claim 1 wherein the lower temperature treatment includes subjecting the coating to a temperature in a range from about below 24° C. to a temperature just above a freezing point of the organic solvent.

17. The method according to claim 16 wherein the solvent is acetone, and wherein the lower temperature treatment includes subjecting the coating to a temperature in a range from about below 24° C. to a temperature just above about −94° C.

18. The method according to claim 16 wherein the solvent is toluene, and wherein the lower temperature treatment includes subjecting the coating to a temperature in a range from about below 24° C. to a temperature just above about −94° C.

19. The method according to claim 16 wherein the solvent is chloroform, and wherein the lower temperature treatment includes subjecting the coating to a temperature in a range from about below 24° C. to a temperature just above about −65° C.

20. The method according to claim 1 wherein said coating inhibits the settlement of marine organisms selected from the group consisting of algae zoospores, diatoms, bacteria, tubeworms, and barnacles.

21. The method according to claim 1 wherein said coating is applied to a surface of a material selected from the group consisting of nylon, silicon, polyester, polyethylene, metal, and glass.

22. The method according to claim 21 wherein said metal is steel.

23. An antifouling coating for application to a surface for preventing marine biofouling in marine environments produced according to the method of claim 1.

23. An antifouling coating produced according to the method of claim 1 applied to a surface of a material selected from the group consisting of nylon, silicon, polyester, polyethylene, metal, and glass.
